(19) United States
(12) Patent Application Publication
(10) Pub. No.: US 2005/0151310 A1
(43) Pub. Date: Jul. 14, 2005

(54) Spring washer

(75) Inventor: Mark A. Rodeffer, Bristol, CT (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Barnes Group, Inc., a corp. of Delaware

(21) Appl. No.: 10/757,284

(22) Filed: Jan. 14, 2004

(51) Int. Cl. F16F 1/34

(52) U.S. Cl. 267/161

(57) ABSTRACT

A spring washer for producing a load in an axial direction which includes an outer spring body extending about a central washer axis parallel to the axial direction. The washer further includes a central opening coaxial to the washer axis for accepting at least a portion of an elongated object extending in the axial direction. The washer has a plurality of circumferentially spaced spring fingers each extending inwardly towards the central washer opening. Each finger including a finger base attached to the outer body and a finger end adjacent to the central opening. The finger end of every other one of the plurality of spring fingers being axially spaced on either side of said outer spring body.

This invention relates to the art of spring washers and, more particularly, to a slotted spring washer for applying axial loads.

### INCORPORATION BY REFERENCE

The present invention relates to spring washers which are capable of producing an axial load. Knocke U.S. Pat. No. 3,009,176 discloses a Belleville spring washer utilized in a bolt assembly and is incorporated by reference for showing the same. Schober U.S. Pat. No. 4,039,354 discloses a method of making a Belleville spring and is incorporated by reference herein for the same. Labesky U.S. Pat. No. 6,102,382 discloses a Belleville spring and is incorporated by reference herein as background material for showing the same. Johnson U.S. Pat. No. 3,259,383 discloses a slotted spring washer and is incorporated by reference herein for showing the same.

### BACKGROUND OF THE INVENTION

It is, of course, well known that a washer can be used to produce an axial load. Further, it is well known that a Belleville or a slotted spring washer can be used to produce the axial load. These axial loads can be utilized to prevent loosening and/or the loss of a bolt by utilizing the axial load to prevent rotation of the bolt relative to another object. Further, the axial load can be used in connection with clutch or brake mechanisms in equipment to create axial loads necessary to produce short axial movements. The axial loads produced by Belleville-style springs can also be used in connection with bearing assemblies, switch gears and other mechanical devices requiring axial loads.

The function of the spring washer and the Belleville-style spring washer is similar. In this respect, the spring washers or Belleville-style spring washers deflect or flatten at a given spring rate once subjected to and applied axial load. The flattened or deflected washer then produces an equal and opposite axial load based on the amount of deflection or flattening of the washer. The axial load is a function of the material utilized to manufacture the washer and the configuration of the washer.

A prior art Belleville-style spring is a conically-shaped disk wherein the cone shape is flattened as the axial load is applied to the washer. With respect to a nut and bolt fastener, as the nut is threaded onto the bolt and engages the washer, continued tightening of the nut begins to flatten the washer wherein the flattened washer maintains the axial load which has been applied by the threaded nut. The axial load is basically equal and opposite to the load applied by the nut except for frictional losses in applying the load.

However, the spring rate of a prior art Belleville-style washer is very high due to its conical configuration. Deflection of the cone shape takes a significant amount of force per the level of deflection. Furthermore, Belleville-style washers known in the art produce forces which change exponentially per unit of deflection. Therefore, they produce/high axial load per unit of deflection (high spring rate) and are increasingly difficult to adjust to a desired axial load as they are compressed. While high axial loads can be used for some applications, producing a desired axial load can be difficult.

Another disadvantage with Belleville-style washers is the limited range of deflection which can be used for producing a controllable and repeatable axial load. This condition is due to the conical configuration and the resulting high stresses produced after only a limited amount of deflection. In this respect, after only a minimal deflection, the stresses in the Belleville washer increase to a point were the washer is permanently deformed. As can be appreciated, a washer will not function the same after it has been permanently deformed.

Slotted spring washers are also conical and have a limited range of motion. However, a slotted spring washer provides only a very light load which is a function of the geometry of the slots and the configuration of the ring connecting the fingers.

Both the Belleville-style washer and the slotted washer have a defined top and bottom in that the top and the bottom are a different diameter due to the conical configuration. As a result, Belleville-style washers and slotted washers must be assembled based on a desired orientation of the top and the bottom of the washer. As can be appreciated, the need to manipulate a washer to distinguish the top and the bottom of the washer can be very difficult and costly in both manual assembly operations and in automated assembly operations.

### SUMMARY OF THE INVENTION

In accordance with the present invention, provided is a spring washer for producing an axial load wherein the axial load is more easily controllable. In this respect, a washer in accordance with the present invention includes multiple spring fingers which have a higher degree of deflection per generated axial load than prior art washers.

A spring washer according to one aspect of the present invention can utilize spring fingers which extend at different angles to produce a wider range of axial loads.

In accordance with another aspect of the present invention, provided is a spring washer which comprises an outer spring body extending about a washer axis wherein the spring fingers extend inwardly towards the spring axis and extend inwardly at different angles to produce the wider range of axial loads.

In accordance with another aspect of the present invention, provided is a spring washer which includes spring fingers extending from both sides of the outer spring body such that the spring washer can be assembled without regard to a top surface or a bottom surface of the washer.

In accordance with yet another aspect of the present invention, the spring washer includes a continuous outer spring body extending about a central axis of the washer. The spring washer including circumferentially spaced spring fingers which extend inwardly from the body toward a central washer opening wherein every other one of the spring fingers extend away from an opposite side of the outer spring body.

In accordance with even yet another aspect of the present invention, the inwardly extending spring fingers on either side of the washer body together form a conical finger arrangement.

In accordance with yet a further aspect of the present invention, the spring washer includes engagement flats at the ends of the spring fingers for aligned engagement with the object the axial load is applied to.

In accordance with even another aspect of the invention, the fingers of the spring washer have finger ends which together form an inner finger edge that is essentially circular with a diameter smaller than the overall outer diameter of the spring washer.

An object of the present invention is a provision of a spring washer for providing an axial load which produces a wide range of axial loads.

Another object is the provision of a spring washer of the foregoing character which provides easier adjustment to the produced axial load.

Still another object is the provision of a spring washer of the foregoing character which includes engaging surfaces that are close to the central axis of the washer.

Still yet another object is the provision of a spring washer of the foregoing character which can be assembled without regard to a top surface or a bottom surface of the washer.

A further object is the provision of a spring washer of the foregoing character which is economical to manufacture, easy to use in the field, and has a long service life.

### BRIEF DESCRIPTION OF THE DRAWINGS

The foregoing will in part be obvious and in part be pointed out more fully hereinafter in connection with a written description of preferred embodiments of the present invention illustrated in the accompanying drawings in which:

FIG. 1 is a perspective view of a spring washer in accordance with the present invention;

FIG. 2 is a top plan view of the spring washer shown in FIG. 1;

FIG. 3 is a side elevational view of the spring washer shown in FIG. 1;

FIG. 4 is a sectional elevational view taken along line 4-4 in FIG. 2;

FIG. 5 is a sectional elevational view of the spring washer shown in FIG. 1 that is positioned between axially spaced shoulders;

FIG. 6 is a sectional elevational view of a prior art Belleville washer positioned between different axially spaced shoulders;

FIG. 7 is an elevational view of the Spring washer shown in FIG. 1 positioned about a bolt and between a nut and an axially spaced object in a first position;

FIG. 8 is an elevational view of the spring washer shown in FIG. 1 positioned about a bolt and between a nut and an axially spaced object in a second position;

FIG. 9 is a schematic diagram showing overall spring force versus deflection;

FIG. 10 is an elevational view of multiple spring washers shown in FIG. 1 that are stacked in parallel;

FIG. 11 is a side elevational view of multiple spring washers as shown in FIG. 1 that are stacked in series;

FIG. 12 is a perspective view of another embodiment of a spring washer in accordance with the present invention;

FIG. 13 is a perspective view of yet another embodiment of a spring washer in accordance with the present invention; and,

FIG. 14 is a perspective view of even yet another embodiment of a spring washer in accordance with the present invention.

### DESCRIPTION OF PREFERRED EMBODIMENTS

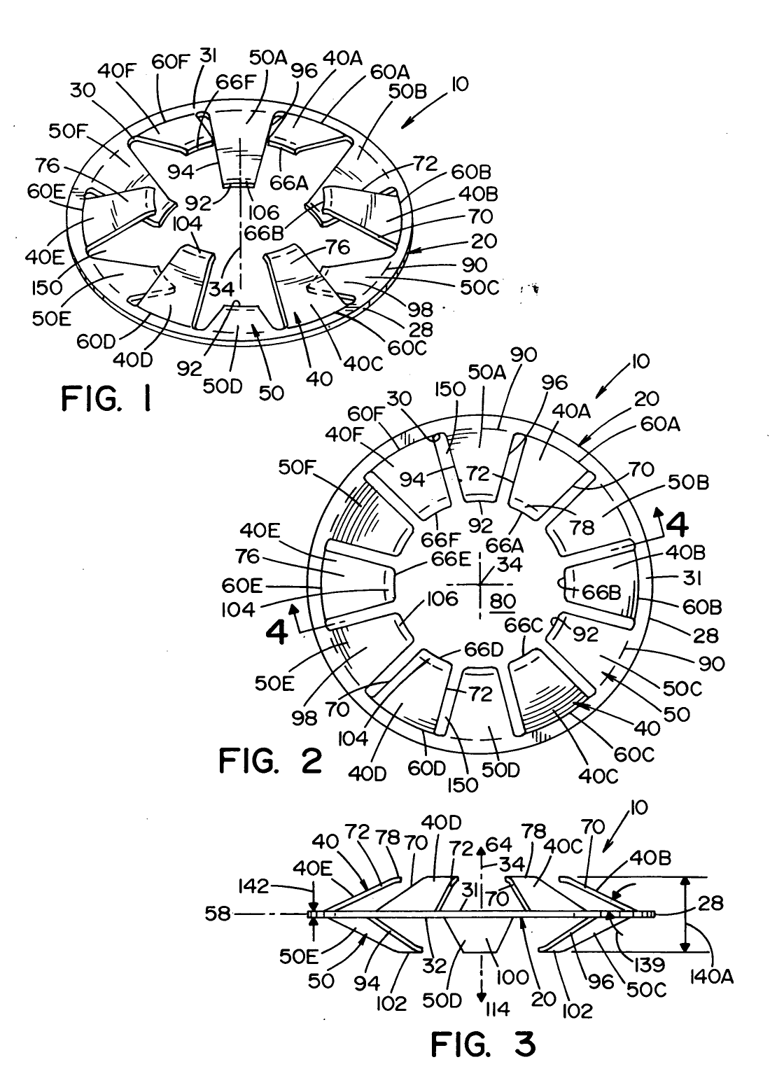

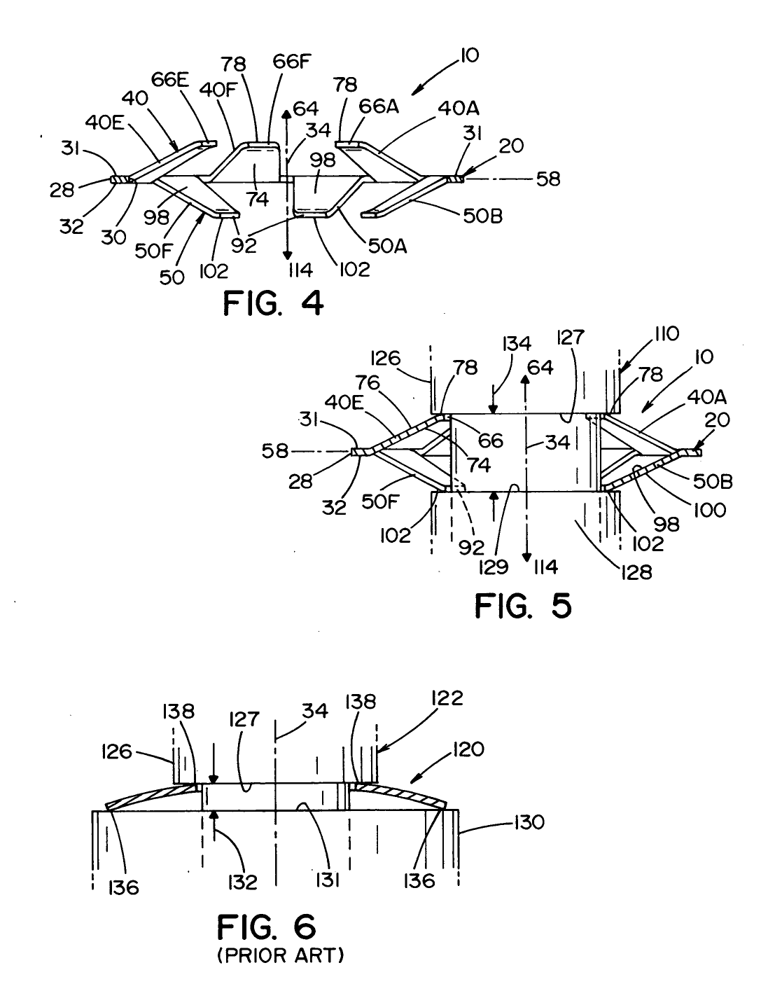

Referring now in greater detail to the drawing wherein the showings are for the purpose of illustrating preferred embodiments of the invention only, and not for the purpose of limiting the invention, FIGS. 1-5 illustrate a spring washer 10 having an outer body 20 which has an outer peripheral edge 28, an inner edge 30, a top surface 31 and a bottom surface 32. Outer body 20 extends about a central washer axis 34 and is shown in this embodiment to be an annular body. Central axis 34 defines an axial direction which is perpendicular to a washer plane 58 that is defined by outer washer body 20. Washer 10 further includes a first set of inwardly extending fingers 40 and a second set of inwardly extending fingers 50. First set of fingers 40 are shown to include six fingers 40A-40F and, similarly, second set of fingers 50 are shown to have six fingers 50A-50F. However, first and second set of fingers 40 and 50 can include more or less than six fingers without detracting from the invention of this application.

First set of fingers 40A-F are attached at a first finger base 60A-F to inner edge 30 of body 20. First set of fingers 40A-F each extend inwardly toward central axis 34 and axially upwardly in a first axial direction 64 to a first finger end 66. First fingers 40A-F each have first finger sides 70 and 72 which extend toward one another from first finger base 60 to first finger end 66. First finger ends 66A-F are arcuate and together form a first inner limit or edge of Spring washer 10 partially defining a circular central opening 80 which will be further discussed below. Fingers 40A-F each have an inner surface 74 generally facing washer plane 58 and an outer surface 76 generally facing first axial direction 64. Outer surfaces 76 together form a top end 78 of washer 10 facing axial direction 64 which can be essentially conical.

Second set of fingers 50A-F are substantially similar to first set of fingers 40A-F and extend from inner edge 30 of washer body 20. Second set of fingers 50A-F are circumferentially spaced from first set of fingers 40A-F about central axis 34 such that one of the second set of fingers 50A-F is on either side of one of the first set of fingers 40A-F. Second set of fingers 50A-F each extend from a second finger base 90 to a second finger end 92 and include second finger sides 94 and 96. Similar to the first set of fingers, second sides 94 and 96 extend inwardly toward one another from second finger base 90 to second finger end 92. Second fingers 50A-F each have an inner surface 98 generally facing washer plane 58 and outer surface 100 generally facing a second axial direction 114. Outer surfaces 100 together form a bottom end 102 of washer 10 facing axial direction 114. Also, similar to the first set of fingers, second finger ends are arcuate and further define a circular central opening 80. However, second set of fingers 50A-F extend inwardly generally toward central axis 34 but at second axial direction 114. First set of fingers 40A-F can be equal and opposite to second set of fingers 50A-F relative to washer plane 58.

First set of fingers 40A-F and second set of fingers 50A-F can further include first and second finger flats 104 and 106, respectively. These finger flats 104 and 106 can be substantially parallel to washer plane 58 for axial engagement with shoulders of an elongated object 110 which will be discussed in greater detail below.

In the first embodiment of this invention, fingers 40A-F are shown to be the same as fingers 50A-F even though that is not required. Furthermore, the fingers are shown to have bases that are wider than the finger ends. In this respect, as is stated above, the finger sides 70 and 72 of the first fingers and the finger sides 94 and 96 of the second finger extend toward one another from the finger base to the finger end. This particular configuration produces finger slots 150 that extend radially inwardly toward central axis 34 having generally parallel sides that are defined by the finger sides. By having a wide finger base, spring washer 10 produces a higher spring rate than a spring washer 10 with a narrow base which will be discussed in greater detail in a later embodiment.

With particular reference to FIGS. 5 and 6, shown are spring washer 10 and a prior art Belleville washer 120. As can be seen, the engagement between spring washer 10 and elongated object 110 is very different than the engagement between prior art Belleville washer 120 and elongated object 122. It should be noted, while the following discussion utilizes a nut and bolt arrangement, the invention of this application has much broader applications and should not be limited by this discussion. Elongated object 110 includes a bolt 126 with a shoulder 127 and a washer 128 with a shoulder 129. Elongated object 122 also includes bolt 126 with shoulder 127, however, object 122 must utilize a wider washer 130 with a shoulder 131. By utilizing inwardly extending fingers that extend axially from opposite axial sides of outer washer body 20, spring washer 10 can utilize a much smaller washer 128. The conical configuration of Belleville washer 120 necessitates a much larger diameter washer 130. In this respect, prior art washer 120 has a bottom edge or engagement point 136 that must be radially spaced from a top edge or engagement point 138 to produce the conical configuration of washer 120. Therefore, bottom edge 136 requires washer 130 having a significantly greater diameter. Conversely, the engagement points on both axial sides of washer 10 can be close to axis 34 allowing use with smaller diameter shoulder 129.

As stated above, the first set of fingers 40A-F extend inwardly generally toward the central axis 34 and away from washer plane 58 toward first axial direction 64 and second set of fingers 50A-F extend away from washer plane 58 toward second axial direction 114 such that washer 10 has an at rest height or free height 140A between ends 78 and 102. The at rest height is a function of the diameter of outer body 20, length of the spring fingers and also the bend angle of the spring fingers relative to washer plane 58. Shown are spring fingers 40A-F and 50A-F with a bend angle 139 of approximately 30 degrees. However, this bend angle can differ based on the application, the desired free height of the washer and the desired axial load of the washer. This range of bend angles is typically between 10 degrees and 50 degrees, however, it is not limited to this range. As a result, when shoulders 127 and 129 engage top end 78, and bottom 102, respectively, fingers 40A-F and 50A-F begin to deflect toward washer plane 58 thereby reducing the washer height and producing an axial load based on the deflection of the spring fingers. As will be discussed in greater detail below, the deflection of the spring fingers produces axial load which is a function of the size and configuration of the fingers of washer 10 along with the spring steel utilized to make the washer including the thickness of the material. Washer 10 has a thickness 142 which is essentially uniform throughout the spring washer except for changes in thickness produced by the manufacturing process. Due to the conical configuration of prior art washer 120, spacing 132 between shoulder 127 and shoulder 131 is much smaller than spacing 134 of elongated object 110 as the objects engage the respective washers at their respective free height or at rest conditions. As a result, washer 10, which is made from a similar thickness material, can be flattened or deflected significantly more than washer 120 which provides a much greater level of adjustment for adjusting the axial load produced by the washer.

As is known in the art, the load produced by a spring is a function of the properties of the spring steel, the configuration of the steel, and the level of deflection of this configuration. The properties of the spring steel in view of the configuration of the steel are used to calculate a spring rate for the specific spring. All spring steels can be used in connection with the invention of this application. This includes, but is not limited to, 1074 and 1095 spring steels, full hard stainless steels, and 1035 hot rolled steel. Turning to the configuration for spring washer 10, fingers 40A-F and 50A-F extend inwardly toward the central washer central opening 80 and away from washer plane 58, respectively. This finger configuration creates the deflection points for washer 10.

The spring washer 10 can be formed from a sheet of spring steel by any known means in the art for producing a desired profile out of sheet material. This can include stamping processes either with multiple hit dies or progressive dies. As is known in the art, the multiple hit dies involve separate die sets which perform different metal cutting and/or metal forming processes to produce the given profile and shape of the desired metal component or the spring washer. With respect to progressive dies, one die set can be used to both produce the profile of the spring washer and the bend(s) in the spring fingers. The die sets for either the multiple hit dies or the progressive dies can produce one or a plurality of spring washers per each cycle of the die. It should also be noted that other metal cutting and forming processes can be utilized without detracting from the invention of this application. In this respect, laser and/or plasma cutting can be utilized to cut the profile of the spring washer. Again, any known process in the art for cutting and/or shaping spring steel can be utilized to produce the spring washer of this application.

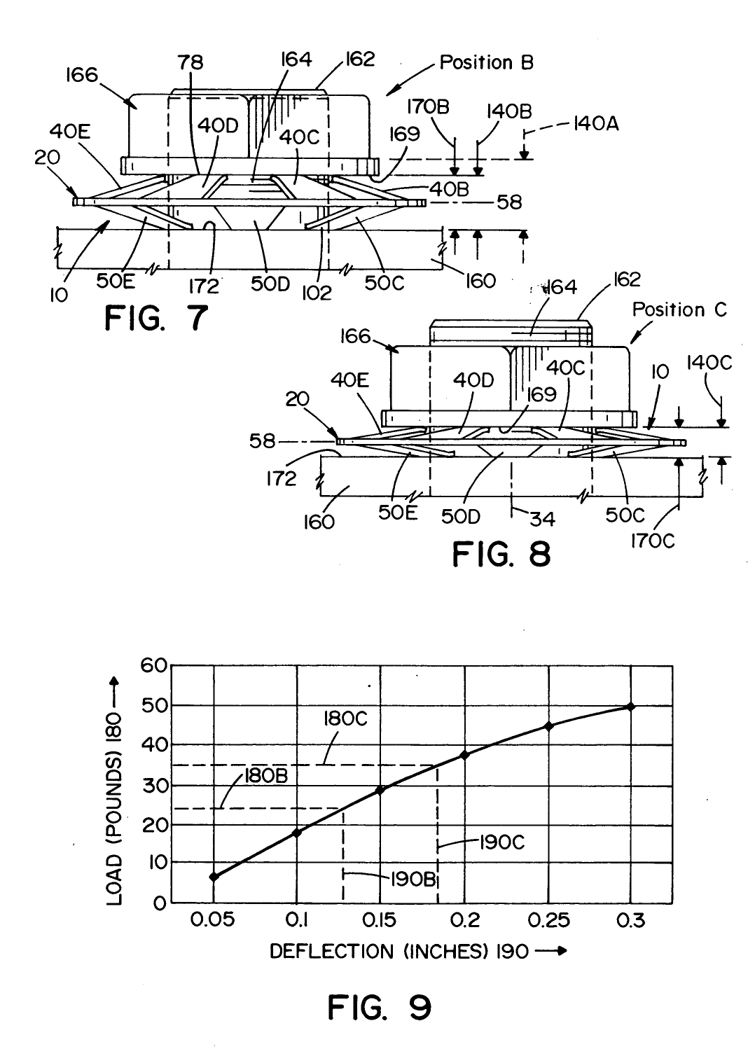

With particular reference to FIGS. 7-9, shown is an example of the deflection of the spring washer of this application, along with a schematic diagram graphing the resulting axial loads produced. This particular deflection diagram relates to a spring washer according to the present invention with a 3.250 inch outside diameter, a 1.600 inch inside diameter for the finger inner ends, a 3.000 inch inner edge diameter, 12 spring fingers such that six are facing in either direction, a free height of 0.720 inches and a bend angle of approximately 30 degrees. The material thickness of the spring washer is 0.020 inches and the spring steel is MARTINSITE.

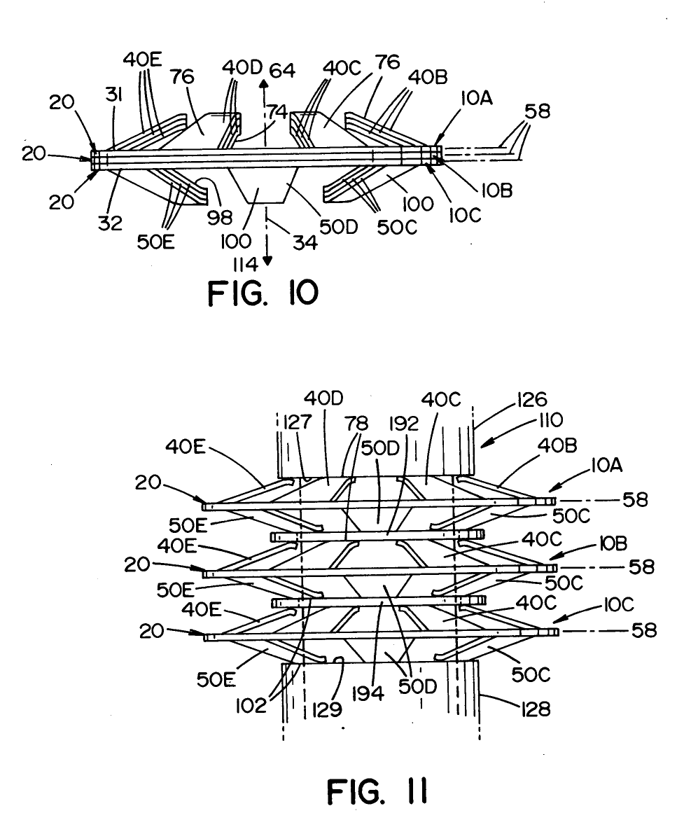

FIGS. 7 and 8 show a base 160 with a threaded member 162 extending from base 160 and having outer threads 164. Further shown is a nut 166 having inner threads (not shown) for engagement with threads 164 and a bottom surface 169. As nut 166 is threaded onto member 162, the spacing 170 between surface 169 and a top surface 172 of base 160 is reduced until the spacing equals free height 140A wherein surface 169 engages top end 78 while bottom end 102 rests on a top surface 172 of base 160 (Position A—which is not shown wherein washer 10 is at its free height 140A). At this point, there is no axial force or load produced by washer 10. Then, as nut 166 is threaded further onto member 162, the fingers of washer 10 begin to deflect toward washer plane 58 thereby producing an axial load as is graphed in FIG. 9. FIG. 7 shows a Position B wherein nut 166 has been threaded to a point which produces a gap 170B between the surfaces 169 and 172 thereby compressing washer 10 to a height 140B. The compression of washer 10 from its relaxed height 140A to partially compressed height 140B produces an axial load 180B resulting from a deflection 190B of washer 10. The axial deflection is a function of the difference between washer height 140B and washer free height 140A. As nut 166 is threaded further onto member 162 to a Position C, there is a spacing 170C between surfaces 169 and 172. As a result, washer height 140C is produced. Accordingly, washer has an axial deflection 190C which produces an axial load 180C. As can be appreciated, based on the bend angles of the fingers, the axial load 180 can increase gradually as deflection 190 increases and can produce a wide range of axial loads. With a Belleville washer, the load increases at a much greater rate as compared to the amount of deflection as a result of the conical configuration of the washer and the limited range of deflection that is possible due to the conical configuration.

Referring to FIGS. 10 and 11, multiple spring washers 10 can be utilized to help increase the axial load produced by spring washer 10 and/or to further increase the adjustability of the washer. As discussed above, the configuration, size and material utilized for spring washer 10 determines the spring rate of the washer. For example, thicker spring steel can be utilized to increase the spring rate. In addition utilizing different steels and/or different heat treating methods can change the spring rate. Any of these changes can influence the axial loads produced by washer 10. Another way in which to increase the axial load produced by washer 10 is by utilizing multiple washers. Shown are spring washers 10A, 10B and 10C which are stacked on one another in two different configurations. In FIG. 10, spring washers 10A-10C are stacked directly on top of one another in parallel such that surfaces 32, 74 and 100 of washer 10A rest directly on the top surfaces 31, 76 and 98, respectively, of washer 10B and, similarly, the bottom surfaces 32, 74 and 100 of washer 10B rest directly on the top surfaces 31, 76 and 98, respectively, of washer 10C. This stacking configuration increases the axial load which can be produced by washer 10 without sacrificing the range of deflection of the washer thereby maintaining the desired adjustability for the resulting produced axial load.

FIG. 11 shows a different stacking arrangement wherein the washers 10A, 10B and 10C are stacked in series such that bottom end 102 of washer 10A engages top end 78 of washer 10B via a first intermediate flat washer 192. Similarly, bottom end 102 of washer 10B engages top end 78 of washer 10C via a second intermediate washer 194. While this arrangement does not change the axial load which can be produced by the washers, this arrangement changes the spring rate of the system. In this respect, an applied load will produce the same amount of deflection in each washer regardless of whether the load is applied by shoulders 127 and 129 or is transmitted through an adjacent washer. Therefore, an applied load will produce three times the deflection when applied to three washers in series as compared to the same load applied to a single washer. This arrangement can be used to further increase the range of adjustability for the produced axial load.

In the following discussions concerning other embodiments, the components of the spring washer 10 which remain the same as discussed above will include the same reference numbers as above.

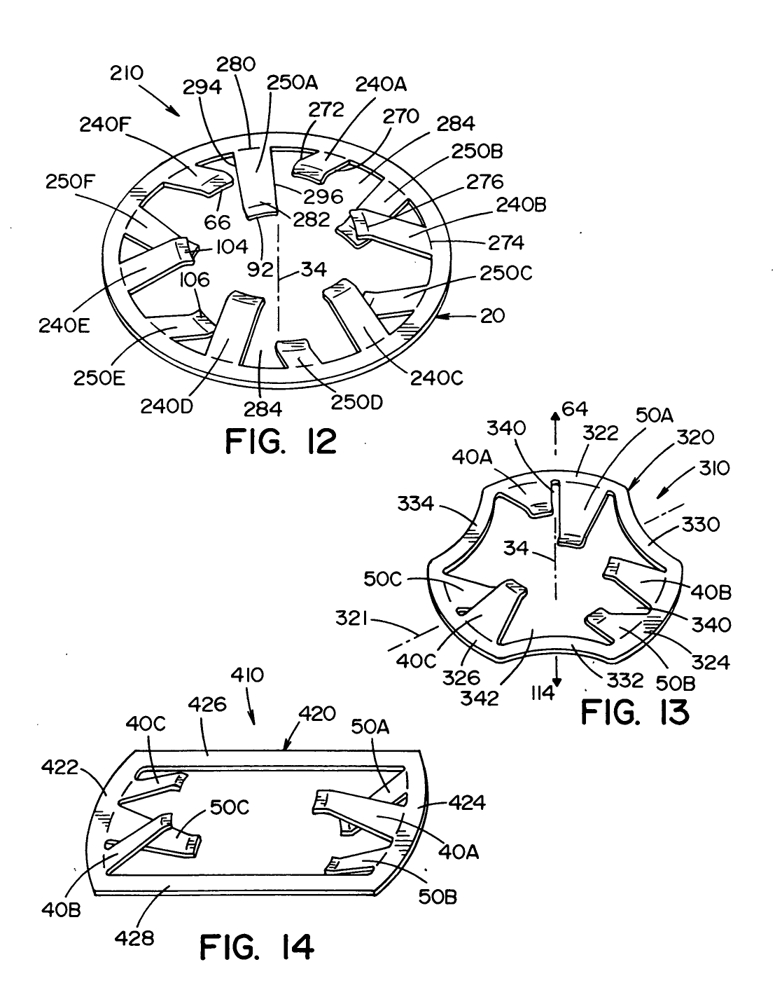

Referring to FIG. 12, shown is spring washer 210 having an outer body 20. However, washer 210 includes fingers 240A-F and 250A-F which have parallel side edges 270 and 272, and 294 and 296, respectively. Side edges 270 and 272 of fingers 240A-F each extending between a finger base 274 and a finger end 276. Similarly, Side edges 294 and 296 of fingers 250A-F each extending between a finger base 280 and a finger end 282. The parallel side edge configuration creates a tapered slot 284 between the spring fingers. This configuration can be used to reduce the axial load of the spring washer without reducing the contact area of each spring finger near finger ends. In this respect, the base configuration of the fingers is part of deflection point for the fingers and narrowing the base reduces the material at the deflection point thereby reducing the spring rate if all other variables are held constant. As can be appreciated, applications which need the same amount of deflection with a different spring rate can be satisfied by changing the finger configuration. As can also be appreciated, the material and/or thickness of material can also be changed to affect the axial load producible by the spring washer.

Referring to FIG. 13, a spring washer 310 is shown which has a different outer configuration. In this respect, washer 310 includes outer washer body 320 defining a washer plane 321 perpendicular to washer axis 34 and having three lobes 322, 324 and 326. Outer body further includes three arcuate bridge portions 330, 332 and 334 joining lobes 322, 324 and 326 to produce continuous outer body 320. Lobes 322, 324 and 326 each include two oppositely extending spring fingers 40 and 50. However, it should be noted that other spring configurations could be used. More particularly, lobe 322 includes spring fingers 40A and 50A wherein finger 40A extends inwardly toward axis 34 and axially in axial direction 64 while finger 50A extends inwardly toward axis 34 and axially in axial direction 114. Similarly, lobe 324 includes spring fingers 40B and 50B wherein finger 40B extends inwardly toward axis 34 and axially in axial direction 64 while finger 50B extends inwardly toward axis 34 and axially in axial direction 114. Lobe 326 includes spring fingers 40C and 50C wherein finger 40C extends inwardly toward axis 34 and axially in axial direction 64 while finger 50C extends inwardly toward axis 34 and axially in axial direction 114. This configuration produces parallel slots 340 and wide gaps 342. As can be appreciated, the parallel sided fingers shown in FIG. 12 could also be utilized in the triangular washer configuration of washer 310.

Referring to FIG. 14, shown is spring washer 410 having outer washer body 420 which includes arcuate ends 422 and 424 and straight sides 426 and 428 joining ends 422 and 424 together forming continuous outer body 420. Outer body end 424 includes finger 50A, 40B and 50B while end 422 includes fingers 40B, 50C and 40C. Again, the fingers shown for spring washer 410 are similar to those utilized in spring washer 10 and will not be discussed in greater detail. Different finger configurations, such as those shown in FIG. 12 could also be utilized with respect to spring washer 410 without detracting of the invention of this application.

While considerable emphasis has been placed on the preferred embodiments of the invention illustrated and described herein, it will be appreciated that other embodiments can be made and that many changes can be made in the preferred embodiments without departing from the principles of the invention. Accordingly, it is to be distinctly understood that the foregoing descriptive matter is to be interpreted merely as illustrative of the invention and not as a limitation.

1. A spring washer for producing a load in an axial direction, said spring washer comprising an outer spring body extending about a central washer axis parallel to said axial direction, a central opening being coaxial to said central washer axis, a plurality of circumferentially spaced spring fingers each extending inwardly generally toward said central washer opening, said each finger having a finger base attached to said outer body and a finger end adjacent to said central opening, said finger end of every other one of said plurality of spring finger being axially spaced on either side of said outer spring body.

2. The spring washer of claim 1, wherein said spring body is annular.

3. The spring washer of claim 1, wherein said plurality of circumferentially spaced spring fingers is at least 6 spring fingers.

4. The spring washer of claim 1, wherein said plurality of circumferentially spaced spring fingers is at least 10 spring fingers.

5. The spring washer of claim 1, wherein said plurality of circumferentially spaced spring fingers is 12 spring fingers.

6. The spring washer of claim 1, wherein said finger ends of said plurality of circumferentially spaced spring fingers together form an innermost edge of said washer.

7. The spring washer of claim 6, wherein said innermost edges is generally circular and coaxial to said washer axis.

8. The spring washer of claim 6, wherein said each finger has two sides extending between said finger base and said finger end, said two sides of said each finger extending inwardly and toward one another.

9. The spring washer of claim 8, wherein said two sides of said each finger extend inwardly and toward one another at equal angles.

10. The spring washer of claim 9, wherein said outer spring body defines a washer plane perpendicular to said central washer axis and said each finger has a flat portion adjacent to said finger end which is generally parallel to said washer plane,

11. The spring washer of claim 10, wherein said flat portions of said plurality of spring fingers are equally spaced from said washer plane.

12. The spring washer of claim 1, wherein said each finger has two sides extending between said finger base and said finger end, said two sides of said each finger extending inwardly and toward one another.

13. The spring washer of claim 12, wherein said outer spring body defines a washer plane perpendicular to said central washer axis and said each finger has a flat portion adjacent to said finger end which is generally parallel to said washer plane.

14. The spring washer of claim 13, wherein said flat portions of said plurality of spring fingers are equally spaced from said washer plane.

15. The spring washer of claim 1, wherein said outer spring body defines a washer plane perpendicular to said central washer axis and said each finger has a flat portion adjacent to said finger end which is generally parallel to said washer plane.

16. The spring washer of claim 15, wherein said flat portions of said plurality of spring fingers are equally spaced from said washer plane.

17. The spring washer of claim 1, wherein said central opening is shaped to receive at least a portion of an elongated object extending in said axial direction.

18. A spring washer comprising a continuous outer spring body extending about a central washer opening, said spring body defining a spring body plane, a plurality of circumferentially spaced spring fingers extending inwardly from said body toward said central washer opening and away from said spring body plane, every other one of said plurality of spring finger also extending away form an opposite side of said spring body plane.

19. A spring washer comprising a annular spring body extending about a central washer opening, said spring body having an inner edge facing said washer opening, an outer peripheral edge, sides extending between said inner and outer edges, a plurality of circumferentially spaced spring fingers extending inwardly from said inner edge of said body toward said central washer opening, a first set of said plurality of spring finger extending away form one side of said spring body plane and a second set of said plurality of spring finger extending away form the other side of said spring body plane.

20. A spring washer comprising a spring body having an inner edge, an outer peripheral edge, a top and a bottom, said body extending about a washer axis and defining a washer plane perpendicular to said washer axis, a first set of spring fingers extending inwardly and upwardly from said inner edge and a second set of spring fingers extending inwardly and downwardly from said inner edge.

21. The spring washer of claim 20, wherein each one of said second set of spring fingers is circumferentially spaced on either side of one of said first set of spring fingers.

22. The spring washer of claim 20, wherein said first set of spring fingers and said second set of spring fingers includes an equal number of fingers.

23. The spring washer of claim 20, wherein each of said first set of spring fingers has a inner finger edge and each of said second set of spring fingers has an inner finger edge, said inner finger edges of said first and second set of fingers together forming an innermost edge of said washer.
